(19) United States
(12) Patent Application Publication
(10) Pub. No.: US 2019/0118357 A1
(43) Pub. Date: Apr. 25, 2019

(54) Magnetic attraction structure for screw bit

(71) Applicant: Ting Ya HUANG, Taichung City (TW)

(72) Inventor: Ting Ya HUANG, Taichung City (TW)

(21) Appl. No.: 15/792,805

(22) Filed: Oct. 25, 2017

(51) Int. Cl. B25B 23/12; B25B 23/00

(52) U.S. Cl. CPC B25B 23/12; B25B 23/0035

(57) ABSTRACT

A magnetic attraction structure for a screw bit contains: a body and a fitting sleeve fitted with the body. The body includes a tip head and an elongated slot formed on a peripheral side of the body adjacent to the tip head. The fitting sleeve includes a peripheral groove, a flexible loop fitted on the peripheral groove, a first through orifice formed in the peripheral groove, a second through orifice arranged on the flexible loop and corresponding to the first through orifice, a steel ball partially accommodated in the first and second through orifices, an accommodated groove formed in an inner wall of the fitting sleeve, and a magnetic attracting element housed in the accommodation groove. When the body fits with the fitting sleeve, a part of the steel ball is retained in the elongated slot of the body via the first through orifice and the second through orifice.

### FIELD OF THE INVENTION

The present invention relates to a magnetic attraction structure for a screw bit in which the fitting sleeve moves forward and backward in the body by moving the steel ball in the elongated slot, hence when the tip head is connected with a bolt element, the fitting sleeve is moved to the tip head so that the magnetic attracting element of the fitting sleeve magnetically attracts with the bolt element.

### BACKGROUND OF THE INVENTION

A conventional screwdriver contains a screw bit formed on a front end thereof so as to connect with a bolt element. However, when the screwdriver is operation in a limited space, its screw bit cannot be connected with the bolt element securely, i.e., the bolt element drops from the screw bit easily.

The present invention has arisen to mitigate and/or obviate the afore-described disadvantages.

### SUMMARY OF THE INVENTION

The primary objective of the present invention is to provide a magnetic attraction structure for a screw bit in which the fitting sleeve moves forward and backward in the body by moving the steel ball in the elongated slot, hence when the tip head is connected with a bolt element, the fitting sleeve is moved to the tip head so that the magnetic attracting element of the fitting sleeve magnetically attracts with the bolt element.

To obtain above-mentioned objective, a magnetic attraction structure for a screw bit provided by a first embodiment of the present invention contains: a body and a fitting sleeve fitted with the body.

The body includes a tip head connected on a front end thereof and includes an elongated slot formed on a peripheral side of the body adjacent to the tip head.

The fitting sleeve includes a peripheral groove defined on an outer wall thereof, a flexible loop fitted on the peripheral groove, a first through orifice formed in the peripheral groove, a second through orifice arranged on the flexible loop and corresponding to the first through orifice of the peripheral groove, a steel ball partially accommodated in the first through orifice and the second through orifice, an accommodated groove formed in a front end of an inner wall of the fitting sleeve, and a magnetic attracting element housed in the accommodation groove.

When the body fits with the fitting sleeve, a part of the steel ball is retained in the elongated slot of the body via the first through orifice and the second through orifice.

In a second embodiment, a magnetic attraction structure for a screw bit contains: a body and a fitting sleeve fitted with the body.

The body includes a first connection extension extending on a first end thereof and fitting with the fitting sleeve, a second connection extension extending on a second end of the body, a coupling trough defined in a first end of the first connection extension, a notch defined on an inner wall of the first connection extension, a spring housed in the notch, and a steel ball biasing on the spring.

The fitting sleeve includes a housing trench formed on an inner wall thereof, an accommodated groove formed in a front end of the inner wall of the fitting sleeve, and a magnetic attracting element housed in the accommodation groove.

When the first connection extension of the body fits with the fitting sleeve, the steel ball is retained in the housing trench of the fitting sleeve.

### BRIEF DESCRIPTION OF THE DRAWINGS

FIG. 1 is a perspective view showing the assembly of a magnetic attraction structure for a screw bit according to a first embodiment of the present invention.

FIG. 2 is a perspective view showing the exploded components of the magnetic attraction structure for the screw bit according to the first embodiment of the present invention.

FIG. 3 is another perspective view showing the assembly of the magnetic attraction structure for the screw bit according to the first embodiment of the present invention.

FIG. 4 is a cross sectional view showing the operation of the magnetic attraction structure for the screw bit according to the first embodiment of the present invention.

FIG. 5 is another cross sectional view showing the operation of the magnetic attraction structure for the screw bit according to the first embodiment of the present invention.

FIG. 6 is a perspective view showing the assembly of a magnetic attraction structure for a screw bit according to a second embodiment of the present invention.

FIG. 7 is a perspective view showing the exploded components of the magnetic attraction structure for the screw bit according to the second embodiment of the present invention.

FIG. 8 is a perspective view showing the operation of the magnetic attraction structure for the screw bit according to the second embodiment of the present invention.

FIG. 9 is another perspective view showing the operation of the magnetic attraction structure for the screw bit according to the second embodiment of the present invention.

FIG. 10 is a cross sectional view showing the operation of the magnetic attraction structure for the screw bit according to the second embodiment of the present invention.

FIG. 11 is another cross sectional view showing the operation of the magnetic attraction structure for the screw bit according to the second embodiment of the present invention.

### DETAILED DESCRIPTION OF THE PREFERRED EMBODIMENTS

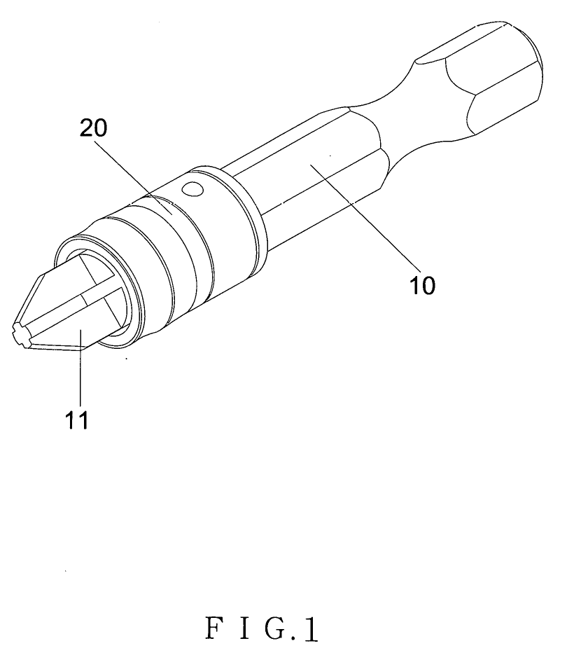

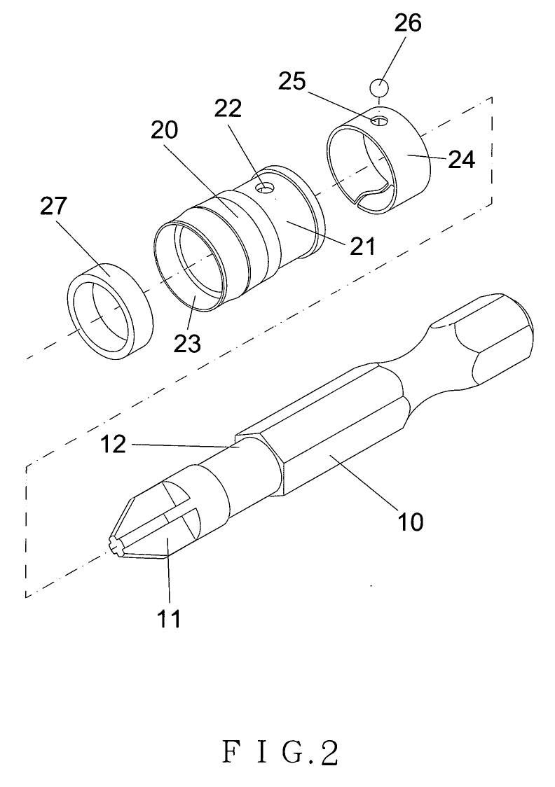

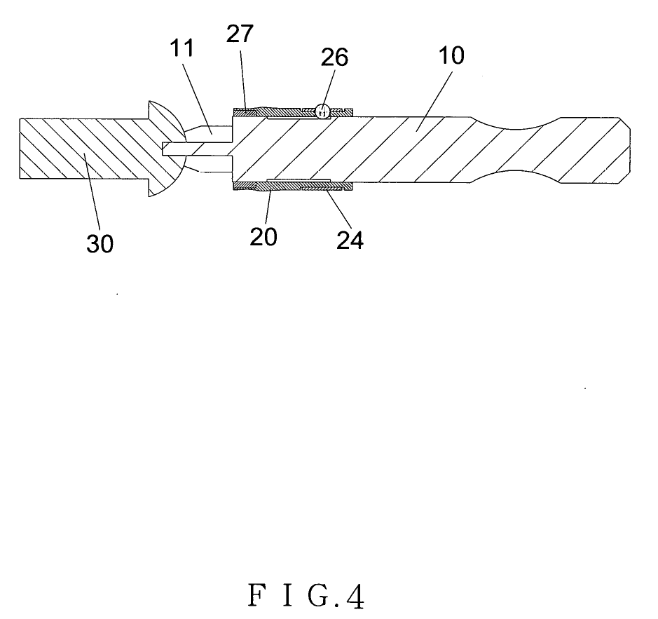

With reference to FIGS. 1-2 and 4, a magnetic attraction structure for a screw bit according to a first embodiment of the present invention comprises: a body 10 and a fitting sleeve 20 fitted with the body 10.

The body 10 includes a tip head 11 connected on a front end thereof and includes an elongated slot 12 formed on a peripheral side of the body 10 adjacent to the tip head 11, the fitting sleeve 20 includes a peripheral groove 21 defined on an outer wall thereof, a flexible loop 24 fitted on the peripheral groove 21, a first through orifice 22 formed in the peripheral groove 21, a second through orifice 25 arranged on the flexible loop 24 and corresponding to the first through orifice 22 of the peripheral groove 21, a steel ball 26 partially accommodated in the first through orifice 22 and the second through orifice 25, an accommodated groove 23 formed in a front end of an inner wall of the fitting sleeve 20, and a magnetic attracting element 27 housed in the accommodation groove 23. When the body 10 fits with the fitting sleeve 20, a part of the steel ball 26 is retained in the elongated slot 12 of the body 10 via the first through orifice 22 and the second through orifice 25.

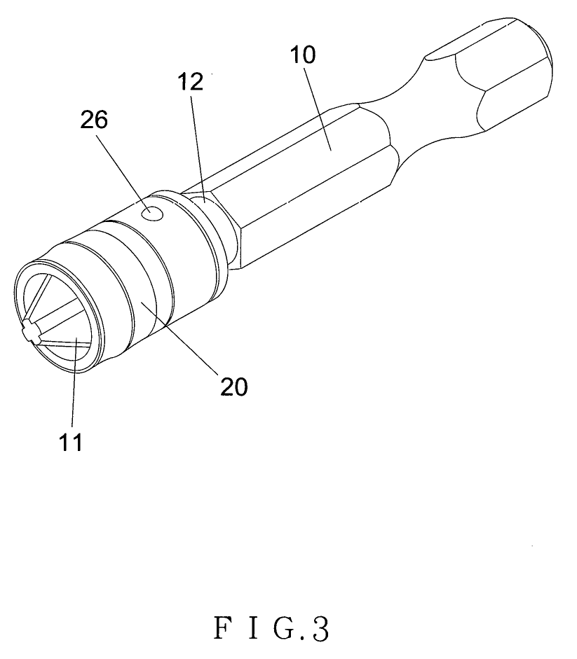

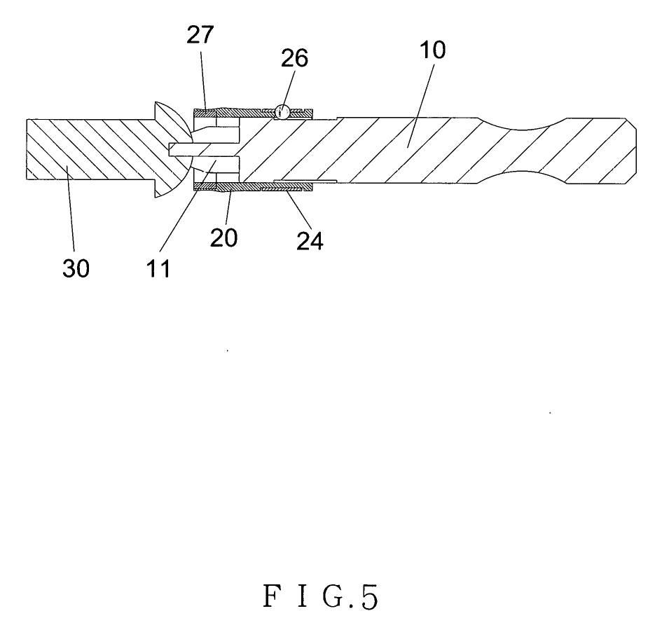

Referring further to FIGS. 1 and 3-5, the fitting sleeve 20 moves forward and backward in the elongated slot 12 of the body 10 by moving the steel ball 26 in the elongated slot 12, hence when the tip head 11 is connected with a bolt element 30, the fitting sleeve 20 is moved to the tip head 11 so that the magnetic attracting element 27 of the fitting sleeve 20 magnetically attracts with the bolt element 30, wherein when the fitting sleeve 20 is removed from the tip head 11, the bolt element 30 removes from the magnetic attracting element 27.

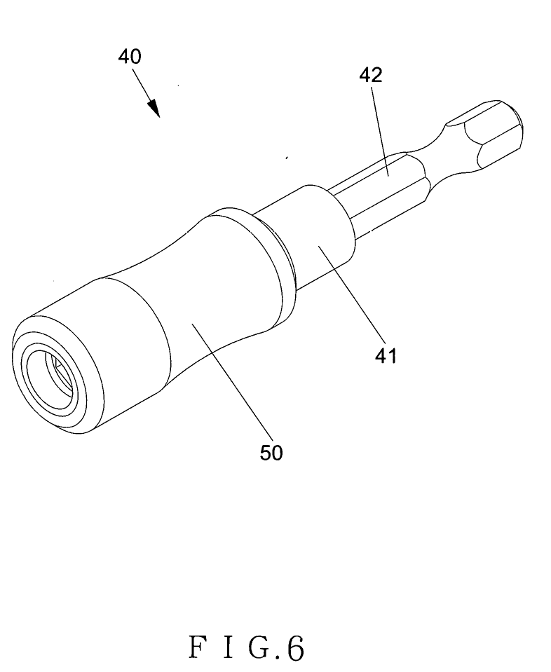

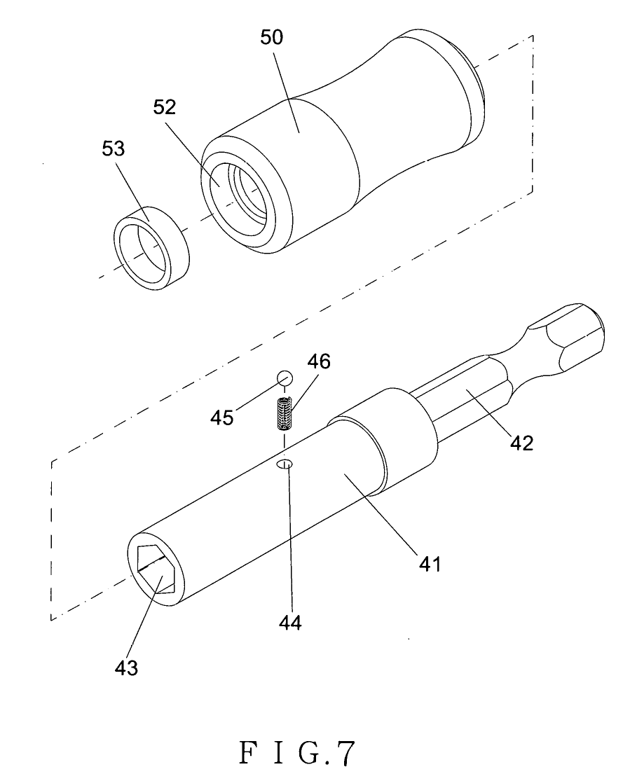

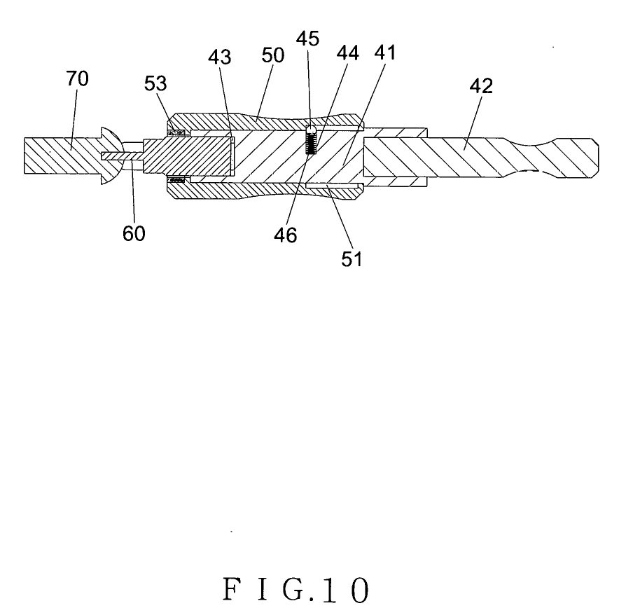

As shown in FIGS. 6-7 and 10, a magnetic attraction structure for a screw bit according to a second embodiment of the present invention comprises: a body 40 and a fitting sleeve 50 fitted with the body 40.

The body 40 includes a first connection extension 41 extending on a first end thereof and fitting with the fitting sleeve 50, a second connection extension 42 extending on a second end of the body 40, a coupling trough 43 defined in a first end of the first connection extension 41, a notch 44 defined on an inner wall of the first connection extension 41, a spring 46 housed in the notch 44, and a steel ball 45 biasing on the spring 46.

The fitting sleeve 50 includes a housing trench 51 formed on an inner wall thereof, an accommodated groove 52 formed in a front end of the inner wall of the fitting sleeve 50, and a magnetic attracting element 53 housed in the accommodation groove 52. When the first connection extension 41 of the body 40 fits with the fitting sleeve 50, the steel ball 45 is retained in the housing trench 51 of the fitting sleeve 50.

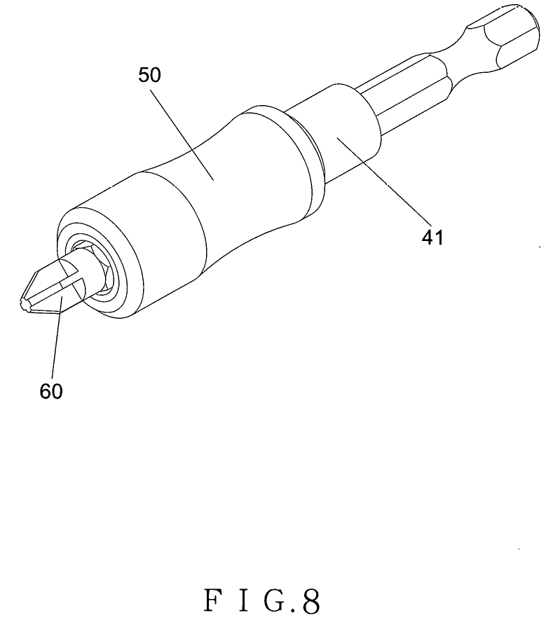

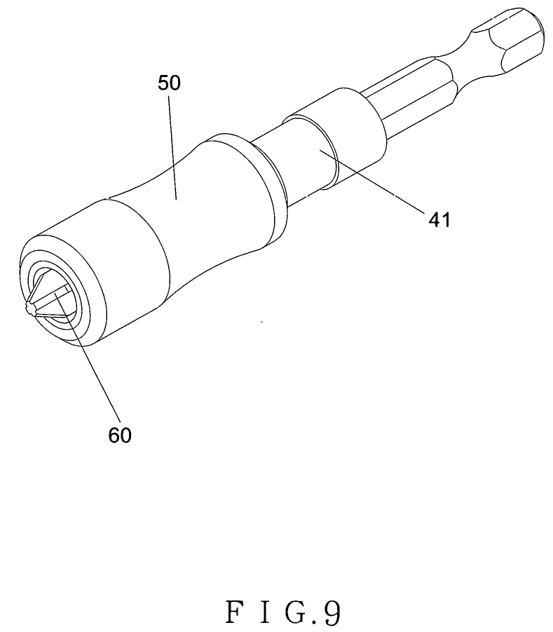

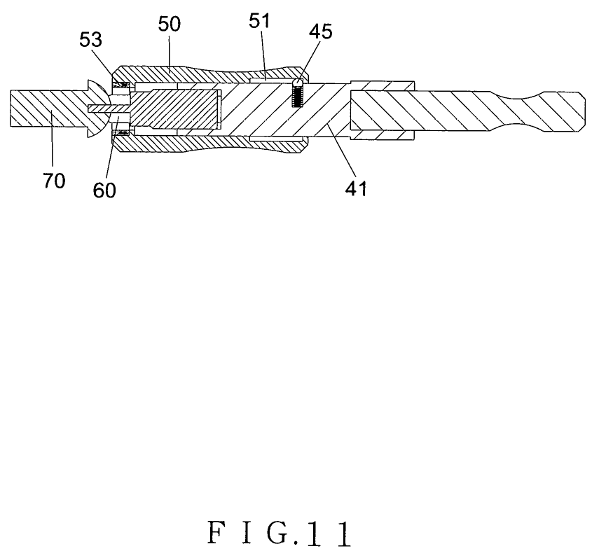

As illustrated in FIGS. 8-11, the coupling trough 43 of the first connection extension 41 is connected with a tip head 60 of the screw bit, and the fitting sleeve 50 is limited in the housing trench 51 by using the steel ball 45 so as to move in the housing trench 51 frontward and backward, wherein when the tip head 60 is connected with a bolt element 70, the fitting sleeve 50 is moved to the tip head 60 so that the magnetic attracting element 53 of the fitting sleeve 50 magnetically attracts with the bolt element 70, wherein when the fitting sleeve 50 is moved away from the tip head 60, the bolt element 70 removes from the magnetic attracting element 53.

Thereby, the fitting sleeve moves forward and backward in the body by moving the steel ball in the elongated slot, hence when the tip head is connected with a bolt element, the fitting sleeve is moved to the tip head so that the magnetic attracting element of the fitting sleeve magnetically attracts with the bolt element.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A magnetic attraction structure for a screw bit comprising: a body and a fitting sleeve fitted with the body;
wherein the body includes a tip head connected on a front end thereof and includes an elongated slot formed on a peripheral side of the body adjacent to the tip head;
wherein the fitting sleeve includes a peripheral groove defined on an outer wall thereof, a flexible loop fitted on the peripheral groove, a first through orifice formed in the peripheral groove, a second through orifice arranged on the flexible loop and corresponding to the first through orifice of the peripheral groove, a steel ball partially accommodated in the first through orifice and the second through orifice, an accommodated groove formed in a front end of an inner wall of the fitting sleeve, and a magnetic attracting element housed in the accommodation groove; and
wherein when the body fits with the fitting sleeve, a part of the steel ball is retained in the elongated slot of the body via the first through orifice and the second through orifice.

2. A magnetic attraction structure for a screw bit comprising: a body and a fitting sleeve fitted with the body;
wherein the body includes a first connection extension extending on a first end thereof and fitting with the fitting sleeve, a second connection extension extending on a second end of the body, a coupling trough defined in a first end of the first connection extension, a notch defined on an inner wall of the first connection extension, a spring housed in the notch, and a steel ball biasing on the spring;
wherein the fitting sleeve includes a housing trench formed on an inner wall thereof, an accommodated groove formed in a front end of the inner wall of the fitting sleeve, and a magnetic attracting element housed in the accommodation groove;
wherein when the first connection extension of the body fits with the fitting sleeve, the steel ball is retained in the housing trench of the fitting sleeve.
